(19) United States
(12) Patent Application Publication
(10) Pub. No.: US 2026/0287107 A1
(43) Pub. Date: Sep. 24, 2026

(54) CONNECTION SYSTEM, CAP AND ADAPTER

(71) Applicant: L’Oréal, Paris (FR)

(72) Inventors: Guillaume Decke, Biel/Bienne (CH); Marc Schlappach, Biel/Bienne (CH)

(21) Appl. No.: 19/474,248

(22) PCT Filed: Apr. 15, 2024
(86) PCT No.: PCT/EP2024/060117

§ 371 Date: Oct. 10, 2025

(30) Foreign Application Priority Data
Apr. 17, 2023 (CH) CH000389/2023

(51) Int. Cl. F16L 37/248; F16L 37/40; F16L 39/02

(52) U.S. Cl. CPC F16L 37/248; F16L 37/40; F16L 39/02

(57) ABSTRACT

A connection system includes a cap and an adapter having cooperating parts of a fastening mechanism for reversibly joining them. The cap includes a first cap side conduit and the adapter includes a first adapter side conduit. The cap also includes a valve element that is movable relative to a cap body from a closed position in which the valve element closes the first cap side conduit to an open position in which it does not. With the cap inserted in the adapter, the adapter engages the valve element and a locking movement of the cap relative to the adapter moves the valve element from the closed position to the open position and establishes a fluid communication between the first cap side conduit and the first adapter side conduit.

### BACKGROUND OF THE INVENTION

### Field of the Invention

The invention relates to the field of devices for docking a container including a fluid to a base station, and relates to a connection system, cap and adapter.

### Description of Related Art

It is known, for example, from WO 2022/106 600 A2, to provide a water conditioning unit for a washing device. The unit includes a base unit configured to provide water with additives admixed to the water. The base unit includes docking adapters, each configured for attaching an additive container. For example, the base unit is used for hair care or cosmetic applications, and the additives provided by the containers can be shampoo or colorants.

BR P10703394-0 A2 shows a water outlet installed in a wall, and a hose attachment piece. The hose attachment piece is connected to the outlet by a bayonet connection. When securing the connection by rotating part of the attachment piece, a valve formed by concentric cylindrical bodies in the outlet is rotated, opening the valve.

US 2010/147297 A1 discloses a bayonet joint connector for fluid carrying hoses.

### SUMMARY OF THE INVENTION

It is an object of the invention to create a connection system, cap and adapter of the type mentioned initially, which allow for simple and easy connection of a container to a base unit.

The connection system includes:
a cap;
an adapter;
the cap and adapter including cooperating parts of a fastening mechanism for reversibly joining the cap to the adapter;
the cap including a first cap side conduit and the adapter including a first adapter side conduit;
the cap including a valve element, the valve element being movable relative to a cap body from a closed position in which the valve element closes the first cap side conduit to an open position in which it does not.
Therein, with the cap inserted in the adapter, the adapter engages the valve element and a locking movement of the cap relative to the adapter moves the valve element from the closed position to the open position and establishes a fluid communication between the first cap side conduit and the first adapter side conduit.

This makes it possible to automatically opening the cap and at the same time establishing a fluid communication between the cap, and a container to which the cap is attached, and the adapter, and a base device to which the adapter is attached.

The connection system is well suited for use with liquids with relatively high viscosity. This can be in combination with a base unit to which the adapter is connected, so that the liquid is provided to the base unit through the adapter. Liquids can be, for example, liquid soaps, shampoo, colorants, cosmetics, conditioners, catalysts, etc. used in hair or body care applications.

In embodiments, the locking movement is a rotation, and in particular the valve element is a valve plate.

In this embodiment, the rotation by the locking movement rotates the valve element and thereby aligns the first cap side conduit with a first valve conduit. The first valve conduit is aligned with the first adapter side conduit by a previous movement of the cap into the adapter. If the valve element is a valve plate, then the first cap side conduit is a through hole or opening in the valve plate, and the locking movement aligns such a first valve opening with the first cap side conduit, establishing a fluid communication between the first cap side conduit and the first adapter side conduit already aligned with the first valve opening.

In embodiments, the fastening mechanism is a bayonet joint, in particular with the cap including at least two radially extending studs and the adapter including at least two bayonet slots.

This allows for a simple and reliable fastening mechanism.

In embodiments,
the cap includes a second cap side conduit and the adapter includes a second adapter side conduit;
wherein the valve element in the closed position closes the second adapter side conduit and in the open position does not;
wherein, with the cap inserted in the adapter, the locking movement of the cap relative to the adapter establishes a fluid communication between the second cap side conduit and the second adapter side conduit.

This makes it possible to implement a compensating air conduit through the second conduits, for replacing a flow of liquid out of the container through the first conduits.

In embodiments, the second adapter side conduit is in fluid communication with the ambient air.

This makes it possible for ambient air to compensate for the outflow.

In embodiments, the second cap side conduit includes a check valve arranged to stop liquid from flowing out of the cap through the second cap side conduit.

In embodiments, the second cap side conduit is designed to extend towards a distal end of a container to which the cap is attached. This makes it possible to eliminate the check valve.

In embodiments, the connection system includes product sensing electrodes, with at least a first product sensing electrode arranged in the cap, on an inner side of the cap, and wherein the adapter includes a contact pin arranged to establish, when the cap is inserted in the adapter, an electrical connection with the first product sensing electrode.

The inner side of the cap is its side that is in fluid communication with an inside of a container to which the cap is attached. With the first product sensing electrode arranged in the cap it is possible to determine the presence of a liquid in the container. The first product sensing electrode can be implemented by a central pin or screw. In embodiments, this pin or screw also serves as an axle rotatably holding the valve element or valve plate.

In embodiments, the connection system includes a second product sensing electrode arranged in the first adapter side conduit.

This allows to measure the presence of liquid in the container with only one sensing electrode an associated contact element being required in the cap. A measurement current can flow through the liquid surrounding the inside of the cap and through the first cap side conduit and first adapter side conduit to the second product sensing electrode.

In embodiments, both product sensing electrodes are arranged in and part of the adapter. In this case, the first product sensing electrode can be part of the adapter and be arranged to puncture the cap when the cap is inserted in and locked to the adapter. After puncturing the cap, the first product sensing electrode reaches into a volume that is in fluid communication with the volume of the container to which the cap is attached. Typically, the first product sensing electrode is arranged at the centre of the cap, coinciding with the axis of rotation of the connection, that is, its longitudinal axis.

In embodiments, the at least two radially extending studs have different diameters, and the at least two bayonet slots have different widths, corresponding to the respective diameters of the studs.

This ensures that the cap can be inserted in the adapter in only one angular position.

The cap is part of the connection system. The cap includes:
cooperating parts of a fastening mechanism for reversibly joining the cap to an adapter;
a first cap side conduit;
a valve element, the valve element being movable relative to a cap body from a closed position in which the valve element closes the first cap side conduit to an open position in which it does not.

In embodiments, the cap includes exactly three parts: the cap body, the valve element, and a pin acting as an axle around which the valve element is arranged to rotate relative to the cap body.

In embodiments, the cap includes exactly two parts: the cap body and the valve element, with a snap-fit connection that allows the valve element to rotate relative to the cap body.

The adapter is part of the connection system, The adapter includes:
cooperating parts of a fastening mechanism for reversibly joining a cap to the adapter;
a first adapter side conduit;
a receptacle defining an axis of insertion of a circular cylinder;
arranged in or on a front face of the adapter, the first adapter side conduit and at least one of:
   a second adapter side conduit;
   a projection, in particular a stud extending outward parallel to the axis of insertion, or a recess, in particular a hole extending inward parallel to the axis of insertion;
   a contact pin for establishing an electrical contact with a cooperating cap.

The axis of insertion can be defined by an inner surface of the receptacle following a shape of the side of a circular cylinder. The axis of insertion is parallel to the axis of the cylinder.

The front face of the adapter, or contact face, is a face of the adapter that is designed to be adjacent to or in contact with a front face of a cap inserted in and locked to the adapter. The front face is at least approximately normal to the axis of insertion, which corresponds to a longitudinal axis of the adapter.

The base device includes an adapter, and further includes a pump arranged to pump a replacement fluid, typically air, into the second adapter side conduit.

### BRIEF DESCRIPTION OF THE DRAWINGS

The subject matter of the invention will be explained in more detail in the following text with reference to exemplary embodiments which are illustrated in the attached drawings, which schematically show:

FIG. 1 a cap attached to a container;

FIG. 2 an adapter to be attached to a base station (not shown);

FIG. 3 an exploded view of the cap and adapter;

FIG. 4a-4b the cap ready to be linearly inserted into the adapter;

FIG. 5a-5b the cap fully inserted into the adapter;

FIG. 6a-6b the cap rotated to a locked position in the adapter; and

FIG. 7-8 alternative embodiments of the cap and adapter.

### DETAILED DESCRIPTION OF THE INVENTION

In principle, identical or functionally identical parts are provided with the same reference symbols in the figures.

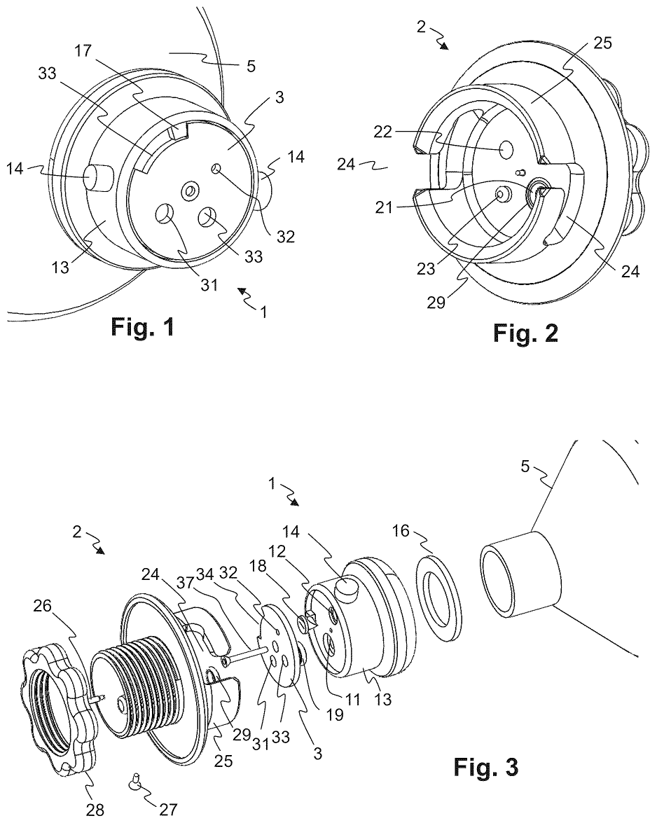

FIGS. 1 and 2 show the main interface elements of the connection system. The connection system includes a cap 1 for a bottle or container 5, and an adapter 2 that is part of a device that is to be supplied with a liquid from the container 5. The cap 1 is releasably connectable to the adapter 2. Connecting the cap 1 to the adapter 2 opens a valve in the cap 1, and disconnecting the cap 1 closes the valve again.

The connection is established by linearly moving the cap 1 and adapter 2 towards and against one another, and then by rotating them relative to one another. The axis of this rotation defines a longitudinal axis of the connection. The direction of the linear movement is in the direction of the longitudinal axis. When in the following an angular position is mentioned, it is understood to relate to a rotation around the longitudinal axis.

The cap 1 (FIG. 1) includes a cap body 13 in which a valve plate 3 is rotatably arranged. The valve plate 3 is surrounded at its circumference by a tubular projection of the cap body 13. At one place along the circumference, the cap body 13 includes stop 17 projecting radially inward. The stop 17 cooperates with a recess 33 at the outer circumference of the valve plate 3, limiting an angular rotation of the valve plate 3 relative to the cap body 13. In a first, closed angular position of the valve plate 3, a first valve opening 31 and a second valve opening 32 of the valve plate 3 are not aligned with corresponding conduits in the cap body 13, thereby closing them. In a second, open angular position, the openings are aligned with respective conduits, thereby opening them. A recess 33 in the valve plate 3 is designed to cooperate with a projection 23 on a front face of the adapter 2, and two studs 14 are designed to cooperate with bayonet slots 24 of the adapter 2 (FIG. 2).

FIG. 2 further shows the adapter 2 including a receptacle 25 into which the cap body 13 is to be inserted, and a first adapter side conduit 21 and second adapter side conduit 22 that, when the cap body 13 is inserted, are aligned with the first valve opening 31 and second valve opening 32, respectively. An O-ring 29 is arranged at the end of the first adapter side conduit 21 facing, when the cap 1 is inserted in the adapter 2, the first valve opening 31.

FIG. 3 shows an exploded view of the cap 1 and adapter 2, with further elements so far not described (see also FIG. 6b with these elements in an assembled configuration): a gasket 16 arranged to establish a liquid-tight seal between the container 5 and the cap body 13. A first cap side conduit 11 and a second cap side conduit 12 leading from a front face of the cap body 13 facing the valve plate 3 to the inside of the container 5. A check valve in the form of a duckbill valve 18 in the second cap side conduit 12. An O-ring 19 between the first cap side conduit 11 and the valve plate 3. A screw or pin 37 for rotatably attaching the valve plate 3 to the cap body 13. A contact pin 26 arranged in the adapter 2, for electrically contacting the pin 37 when the cap 1 is inserted in the adapter 2. A counternut 28 for attaching the adapter 2 in the housing of a base unit (not shown) to which the liquid from the container 5 is supplied.

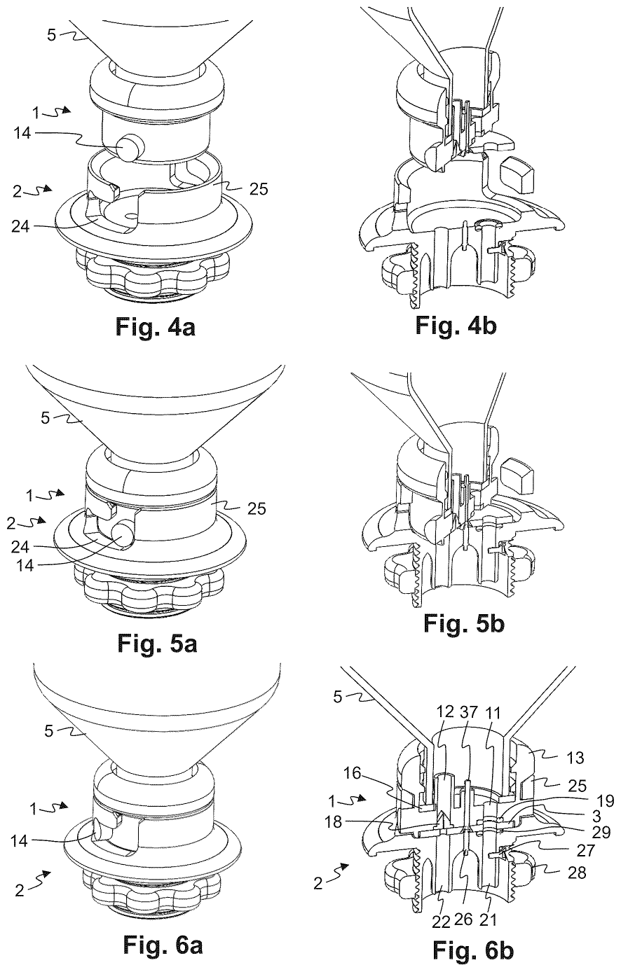

FIGS. 4a-6b show a sequence of movements when connecting the cap 1 to the adapter 2, with a perspective view in FIGS. 4a, 5a, 6a and a cut view in FIGS. 4b, 5b, 6b. In FIGS. 4a and 4b, the cap 1 is aligned with the adapter 2, ready to be inserted. The angular position of the cap 1 around the longitudinal axis is so that the studs 14 of the cap 1 are aligned with the bayonet slots 24 of the receptacle 25. Due to the differently sized pairs of studs 14 and bayonet slots 24 there is only one angle at which this is possible. In FIGS. 5a and 5b, the cap 1 is at the same angular position but is pushed, along the longitudinal direction, into the adapter 2 into its end position, with the valve plate 3 abutting or near a contact face or front face of the adapter 2. The projection 23 in the front face of the adapter 2 engages the recess 33 of the valve plate 3. In alternative embodiments, a projection of the valve plate 3 engages a recess in the front face of the adapter 2. This engagement locks the valve plate's 3 angular position to that of the adapter 2. In this position, the first valve opening 31 and second valve opening 32 of the valve plate 3 are aligned with the first adapter side conduit 21 and second adapter side conduit 22, respectively. In FIGS. 6a and 6b, the cap 1 is rotated relative to the adapter 2. Since the valve plate's 3 angular position is locked to that of the adapter 2, the valve plate 3 is rotated relative to the cap body 13. By this relative rotation, the first cap side conduit 11 and second cap side conduit 12 are aligned with the first valve opening 31 and second valve opening 32, and therefore also with the first adapter side conduit 21 and second adapter side conduit 22. So, the connection is open for a flow through the two conduits between the container 5 and the base device to which the adapter 2 is connected. For removing the container 5 from the adapter 2, the sequence of motion is reversed.

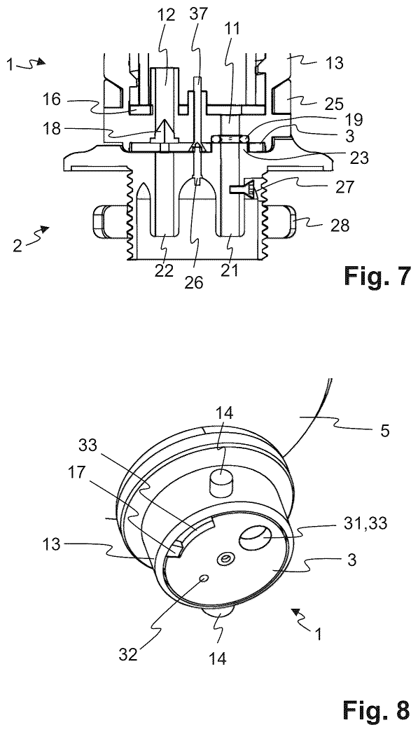

FIGS. 7 and 8 show an embodiment in which the first valve opening 31 and the recess 33 are realised by the same physical hole in the valve plate 3. Correspondingly, the first adapter side conduit 21 leads through the projection 23. The O-ring 29 in the adapter 2 is not required. The operation the same as described for the embodiment of the preceding figures: The projection 23—which incorporates the first adapter side conduit 21—in the front face of the adapter 2 engages the recess 33 of the valve plate 3, and thus the recess 33 also acts as the first valve opening 31. As the valve plate 3 is rotated relative to the cap body 13, the end of the first adapter side conduit 21 slides along the O-ring 19 of the cap 1 and aligns with the first cap side conduit 11. As a result, only a single O-ring is required, and the shape of the valve plate 3 is simplified.

In the embodiments shown, the first cap side conduit 11 and first adapter side conduit 21 are designed to carry a liquid from the container 5 through the adapter 2. The second cap side conduit 12 and second adapter side conduit 22 are designed to carry a replacement fluid, typically air, from the adapter 2 into the container 5. The base device can include a pump that forces the replacement fluid into the container 5, thereby pushing—assuming that the container 5 has no other openings—and aiding the flow of the liquid back into the base device. A check valve, in this case the duckbill valve 18, is arranged to stop liquid from flowing out through the second cap side conduit 12.

In embodiments, the check valve 18 is not present at all, or it is located in the adapter 2 rather than in the cap 1. Instead, starting in the cap 1, an extension conduit can be present that extends the second cap side conduit 12 to a distal end of the container 5. Then, when the container 5 is placed on its head, with the cap 1 at its lowest point, an open end of the extension conduit will be above a surface level of the liquid of the container 5, and the liquid will not flow into the conduit.

In embodiments, the second adapter side conduit 22 does not lead into the base device but is open to the ambient air. In this case, the liquid is drawn from the container 5 by gravity alone, or by a pump after the first adapter side conduit 21. Ambient air is drawn in through the second adapter side conduit 22, replacing the liquid.

In embodiments, the second cap side conduit 12, second adapter side conduit 22 and second valve opening 32 are not present. Instead, the cap 1 or the container 5 includes another opening through which air can flow in to replace liquid flowing out, and/or the container 5 is flexible and shrinks as the liquid flows out.

The pin 37, which can be a screw, acts on the one hand as a central axle of the valve plate 3. In embodiments, the central axle is implemented by a central, rotatable snap-fit connection between the valve plate 3 and the cap body 13. In embodiments, there is no central axle of the valve plate 3, and instead the valve plate 3 is rotatably held at its circumference. This can be effected by a groove running around the inside of a tubular projection, extending from the cap body 13 in the direction of the longitudinal axis, in which the valve plate 3 is arranged.

The pin 37 also acts as a first electrode for detecting the presence of the liquid in the system. The end of the pin 37, reaching through the cap 1, lies on the inside of the container 5. A further electrode 27 is arranged in the first adapter side conduit 21. The presence of the liquid in the volume between the end of the pin 37 and the further electrode 27 can be detected by measuring an electrical impedance between them. An electrical contact to the pin 37, which is part of the cap 1, is established by a contact pin 26 that is part of the adapter 2.

The pin 37 can be made to extend further into the container 5. This allows to derive, from an impedance measurement, not only the presence of the liquid, but also an estimate of the amount of liquid present in the container 5. An insulating sheath around the pin 37 determines a minimum level of liquid. With the level of liquid below this minimum, the impedance between the electrodes becomes very high, corresponding to an empty container 5.

In embodiments, not illustrated, both electrodes are part of the cap 1, and cooperating electrical contacts are arranged on the cap 1 and adapter 2. For example, such contacts can be arranged on the studs 14 of the cap 1 to contact corresponding contacts in the bayonet slots 24 of the adapter 2.

In other embodiments, both electrodes are part of the adapter 2. In this case a third conduit for the liquid can be present in the cap 1, and a corresponding third valve opening in the valve plate 3, leading to an electrode on or in the adapter 2, arranged to be in liquid communication with the third valve opening when the valve plate 3 is in the open angular position.

In embodiments, the base unit to which the adapter 2 is attached includes an electronic circuit for measuring an impedance between the two electrodes, and from determining a filling status of the container 5 to which the cap 1 is attached. The filling status can include the status “empty” and “full”. In embodiments, the filling status includes values representing a degree to which the container 5 is filled. The circuit can be configured to measure the impedance intermittently, in order to prevent electrolysis of the liquid. The circuit can be configured to measure the impedance at least every 0.1 seconds, or at least every second, or at least every five seconds.

In embodiments, the circuit is configured to determine a valid filling status of the container 5, after a container 5 has been attached to the adapter 2, only after a pump drawing the liquid out of the container 5 has been operated for a certain delay time. This ensures that the first adapter side conduit 21 including the electrode 27 is filled with liquid.

In embodiments, not illustrated, the O-ring 19 in the cap 1 and/or the O-ring 29 in the adapter 2 are not present, and the cap body 13, valve plate 3 and/or adapter 2 are shaped and/or made of materials that establish a sufficiently liquid-tight connection.

While the invention has been described in present embodiments, it is distinctly understood that the invention is not limited thereto, but may be otherwise variously embodied and practised within the scope of the claims.

1. A connection system comprising:
a cap;
an adapter;
the cap and adapter comprising cooperating parts of a fastening mechanism for reversibly joining the cap to the adapter;
the cap comprising a first cap side conduit and the adapter comprising a first adapter side conduit;
the cap comprising a valve element, the valve element being movable relative to a cap body from a closed position in which the valve element closes the first cap side conduit to an open position in which it does not;
wherein, with the cap inserted in the adapter, the adapter engages the valve element and a locking movement of the cap relative to the adapter moves the valve element from the closed position to the open position and establishes a fluid communication between the first cap side conduit and the first adapter side conduit.

2. The connection system of claim 1, wherein the cap is attached to a container.

3. The connection system of claim 1, wherein the locking movement is a rotation.

4. The connection system of claim 3, wherein the fastening mechanism is a bayonet joint.

5. The connection system of claim 1, wherein:
the cap comprising a second cap side conduit and the adapter comprising a second adapter side conduit;
the valve element in the closed position closes the second adapter side conduit and in the open position does not; and
with the cap inserted in the adapter, the locking movement of the cap relative to the adapter establishes a fluid communication between the second cap side conduit and the second adapter side conduit.

6. The connection system of claim 5, wherein the second adapter side conduit is in fluid communication with ambient air.

7. The connection system of claim 5, wherein the second cap side conduit comprises a check valve arranged to stop liquid from flowing out of the cap through the second cap side conduit.

8. The connection system of claim 1, comprising product sensing electrodes, with at least a first product sensing electrode arranged in the cap, on an inner side of the cap, and wherein the adapter comprises a contact pin arranged to establish, when the cap is inserted in the adapter, an electrical connection with the first product sensing electrode.

9. The connection system of claim 8, with a second product sensing electrode arranged in the first adapter side conduit.

10. The connection system of claim 4, wherein the at least two radially extending studs have different diameters, and the at least two bayonet slots have different widths, corresponding to the respective diameters of the studs.

11. A cap being part of a connection system according to claim 1, the cap comprising:
cooperating parts of a fastening mechanism for reversibly joining the cap to an adapter;
a first cap side conduit;
a valve element, the valve element being movable relative to a cap body from a closed position in which the valve element closes the first cap side conduit to an open position in which it does not.

12. The cap of claim 11, comprising exactly three parts: the cap body, the valve element, and a pin acting as an axle around which the valve element is arranged to rotate relative to the cap body.

13. The cap of claim 11, comprising exactly two parts: the cap body and the valve element, with a snap-fit connection that allows the valve element to rotate relative to the cap body.

14. An adapter being part of a connection system according to claim 1, the adapter comprising:
cooperating parts of a fastening mechanism for reversibly joining a cap to the adapter;
a first adapter side conduit;
a receptacle defining an axis of insertion of a circular cylinder;
arranged in or on a front face of the adapter, the first adapter side conduit and at least one of:
a second adapter side (22)conduit;
a projection, in particular a stud extending outward parallel to the axis of insertion, or a recess, in particular a hole extending inward parallel to the axis of insertion;
a contact pin for establishing an electrical contact with a cooperating cap.

15. A base device comprising an adapter according to claim 14, and further comprising a pump arranged to pump a replacement fluid, into the second adapter side conduit.
